(19) United States
(12) Patent Application Publication
(10) Pub. No.: US 2022/0164762 A1
(43) Pub. Date: May 26, 2022

(54) DIGITAL SMART LABEL FOR SHIPPER WITH DATA LOGGER

(71) Applicant: Cryoport, Inc., Brentwood, TN (US)

(72) Inventors: Bret Bollinger, Yorba Linda, CA (US); Ben Lee, Corona, CA (US)

(73) Assignee: Cryoport, Inc., Brentwood, TN (US)

(21) Appl. No.: 17/666,361

(22) Filed: Feb. 7, 2022

Related U.S. Application Data
(63) Continuation-in-part of application No. 16/446,123, filed on Jun. 19, 2019.
Application No. 16/446,123 is a continuation-in-part of application No. 14/589,768, filed on Jan. 5, 2015, now abandoned.
(60) Provisional application No. 61/924,399, filed on Jan. 7, 2014.

(51) Int. Cl. G06Q 10/08

(52) U.S. Cl. CPC G06Q 10/083

(57) ABSTRACT

A system for monitoring shipping of a shipping container. The system includes one or more sensors. The one or more sensors are positioned on or within the shipping container. The one or more sensors are configured to measure or detect at least one parameter associated with the shipping container. The system further includes an electronic device. The electronic device is in communication with the one or more sensors. The electronic device is configured to receive, store, and transmit the at least one parameter from the one or more sensors. The system further includes a web portal. The web portal is in communication with the electronic device. The web portal is configured to receive the at least one parameter from the electronic device and display the at least one parameter on a user interface.

### CROSS-REFERENCE TO RELATED APPLICATIONS

This application is a continuation-in-part of U.S. patent application Ser. No. 16/446,123, titled “DIGITAL SMART LABEL FOR SHIPPER WITH DATA LOGGER,” filed on Jun. 19, 2019, which is a continuation-in-part of U.S. patent application Ser. No. 14/589,768, titled “DIGITAL SMART LABEL FOR SHIPPER WITH DATA LOGGER,” filed on Jan. 5, 2015, which claims priority to and the benefit of U.S. Provisional Application No. 61/924,399, filed on Jan. 7, 2014. The entire contents of all referenced applications are hereby incorporated by reference in their entirety.

### BACKGROUND

### 1. Field

This specification relates to shipping containers, particularly a system for monitoring shipping of a shipping container, a system for locking and unlocking a shipping container, and a modular shipping container.

### 2. Description of the Related Art

The present disclosure is especially well suited and adapted for use with packaging systems for cryogenic shipment of various materials including live cell bio-materials, vaccines, tissues, etc., and controlling shipments of materials using such a packaging system. Shipping of temperature controlled materials today usually requires a number of steps that require logistics support which increases cost and the chance for error that can damage the temperature controlled materials during shipping. Further, due to the temperature sensitive and/or fragile nature of the payloads shipped in the shipping containers of such packaging systems, monitoring and tracking the state of the payloads and the conditions the payloads are exposed to and accessibility to such information is imperative. For example, monitoring and tracking parameters such as temperature and humidity inside the shipping container, orientation of the shipping container, and shock endured by the shipping container may be critical in ensuring that the payload is transported safely and not damaged. Moreover, the ability to view such parameters on the shipping containers with an electronic device during the course of shipment may improve the ease and efficiency in detecting irregular or undesirable conditions inside the shipping container that may damage the payload. Integrating such an electronic device onto or into the shipping container where space is saved and the electronic device is securely attached and protected from physical impact may be desirable. Even further, the ability to perform other tasks from the electronic device, such as viewing multiple shipping labels for multiple shipping legs and locking and unlocking the shipping container may improve security, ease of use, simplify the system, save space, and reduce cost.

Accordingly, there is a need for a smart shipping container that enables monitoring of the shipping of the shipping container both from a remote location and the shipping container itself that can also integrate an electronic device onto or within the shipping container where the electronic device can lock and unlock the shipping container.

### SUMMARY

In general, one aspect of the subject matter described in this specification is embodied in a system for monitoring shipping of a shipping container. The shipping container includes one or more sensors. The one or more sensors are positioned on or within the shipping container. The one or more sensors are configured to measure or detect at least one parameter associated with the shipping container. The system further includes an electronic device in communication with the one or more sensors. The electronic device is configured to receive, store, and transmit the at least one parameter from the one or more sensors. The system further includes a web portal in communication with the electronic device. The web portal is configured to receive the at least one parameter from the electronic device and display the at least one parameter on a user interface.

These and other embodiments may optionally include one or more of the following features. The one or more sensors may be positioned within a payload area of the shipping container. The payload area may be configured to receive a payload and maintain a temperature of an environment surrounding the payload. The at least one parameter may be at least one of humidity or temperature within the payload area. The at least one parameter may be at least one of shock endured by the shipping container or an orientation of the shipping container. The electronic device and the web portal may communicate via a cellular connection. The electronic device may be a remote device configured to be removably attached to the shipping container.

In another aspect, the subject matter is embodied in a system for locking and unlocking a shipping container. The system includes a locking mechanism configured to provide access to a payload area of the shipping container in an unlocked configuration and prevent access to the payload area in a locked configuration. The system further includes an electronic device. The electronic device is coupled to the locking mechanism. The electronic device is configured to control the locking mechanism to switch the locking mechanism between the unlocked configuration and the locked configuration based on user input. The system further includes a display. The display is coupled to the electronic device. The display is configured to receive the user input and communicate the user input to the electronic device. The user input is a selection between the unlocked configuration and the locked configuration.

These and other embodiments may optionally include one or more of the following features. The user input may include a code or a password comprising alphanumeric characters or symbols. The system may further include a biometric sensor. The biometric sensor may be coupled to the display. The biometric sensor may be configured to detect biometric information. The user input may include the biometric information. The locking mechanism may include one or more latches configured to secure a lid of the shipping container over a base enclosure of the shipping container. The base enclosure may house the payload area. The electronic device may be a power source for the display.

In yet another aspect, the subject matter is embodied in a modular shipping container. The shipping container includes a lid configured to be opened and closed. The modular shipping container further includes a base enclosure. The base enclosure is coupled to the lid. The base enclosure has a payload area that is configured to receive a payload and maintain a temperature of an environment surrounding the payload. An outer surface of the lid or an exterior wall of the base enclosure defines a cavity configured to house a remote device.

These and other embodiments may optionally include one or more of the following features. The modular shipping container may further include a tray removably attached to the cavity. The tray may be configured to receive the remote device. The tray may include a housing configured to receive the remote device. The housing may conform to a shape of the remote device. The remote device may be attachable to the housing via snap-fitment. The remote device may be a display configured to display one or more electronic image files associated with one or more legs of a shipping itinerary or data measured or detected by one or more sensors positioned within the payload area. The one or more sensors may include a thermocouple. The tray may include wiring configured to electronically couple the display to a data logger configured to receive, store, and transmit the data from the one or more sensors. A front surface of the remote device may be flush with the outer surface of the lid or the exterior wall of the base enclosure when the remote device is housed in the cavity. The remote device may be a data logger configured to receive, store, and transmit data from one or more sensors positioned within the payload area. One or more channels may extend from the cavity. The one or more channels may be configured to secure wiring to electronically couple the data logger to the one or more sensors. The cavity may be foam.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

FIG. 1A shows an example electronic shipping label according to an aspect of the disclosure.

FIG. 1B shows a block diagram of the electronic shipping label of FIG. 1A according to an aspect of the disclosure.

FIG. 2 shows a block diagram of an example shipping and logistics system according to an aspect of the disclosure.

FIG. 3 shows a keypad on the display of the electronic shipping label of the shipping and logistics system of FIG. 1, which controls a lock mechanism on the shipping container, according to an aspect of the disclosure.

FIG. 4 is a flow diagram of an example process for obtaining and providing electronic images to the electronic shipping label using the electronic device of the shipping and logistics system of FIG. 2 according to an aspect of the disclosure.

FIG. 5 is a flow diagram of an example process for displaying shipping information on the electronic shipping label of the shipping and logistics system of FIG. 2 according to an aspect of the disclosure.

FIG. 6 is a flow diagram of an example process for accessing the shipping container through the electronic shipping label of the shipping and logistics system of FIG. 2 according to an aspect of the disclosure.

FIG. 7 shows an example overall web portal architecture for the web portal of the shipping and logistics system of FIG. 2 according to an aspect of the disclosure.

FIG. 8 shows a system for monitoring shipping of a shipping container according to an aspect of the disclosure.

FIG. 9 shows a perspective view of a shipping container of the system of FIG. 8 in an open configuration according to an aspect of the disclosure.

FIG. 10 shows a perspective view of a system for locking and unlocking a shipping container according to an aspect of the disclosure.

FIGS. 11A-B show exploded views of a tray configured to receive a remote device and be removably attached to a shipping container according to an aspect of the disclosure.

FIG. 12 shows a perspective view of a lid of a dewar, the lid having a cavity to house a remote device according to an aspect of the disclosure.

FIG. 13 shows a top view of the dewar of FIG. 12 according to an aspect of the disclosure.

FIG. 14 shows an isolated view of an insert defining the cavity of FIG. 12 according to an aspect of the disclosure.

FIG. 15 shows a cross-sectional view of the dewar of FIG. 12 according to an aspect of the disclosure.

### DETAILED DESCRIPTION

Disclosed herein are systems, devices and/or methods for transporting a shipping container using an electronic shipping label. The electronic shipping label provides real-time display for any type of shipping label configuration regardless of carrier (i.e., bar-coding, formatting, and carrier specific information required, etc.). This shipping label will be applied to one or more locations on the shipper. When modifications are required that will result in needing to change the shipping label, a web portal will send the new information to the electronic shipping label to change the display via an electronic device carried with the shipper, such as a smart data logger or a separate electronic device. Origin, destination, payload, and carrier can all be changed via some type of communication to the label (such as Wi-Fi, cellular or some other type of communication) from the smart data logger or separate electronic device. This reduces paper usage. Currently, on average, 15 pages of 8.5″×11″ paper are used for every international shipment and 6 pages for domestic shipments.

Other benefits and advantages including having the ability to automatically change shipping labels when the shipping container has moved onto another shipping leg of the shipping itinerary automatically without communication from the web portal. For example, once one shipping leg of the shipping itinerary has been completed, the electronic shipping label may automatically switch images to show the next shipping label associated with the next shipping leg. Thus, no coordination is needed between the origin or destination sites to change out paperwork when changes occur to the shipping itinerary or for the next leg of shipment. Currently the client has to pull paperwork from the completed shipping leg, then close a box with a different flap presented with the new leg of the shipping itinerary. This can often get mixed up resulting in the client shipping the commodity to the wrong address.

Additionally, the electronic shipping label may display other electronic images including commercial invoices, hazardous declaration sheets, certificates of origin and other related shipping documents. The status of the electronic device can also be displayed, which provides sensor information like current internal temperature. The electronic shipping label may also display history and statistics of sensor data collected. Instructions on how to load and unload the package can also be displayed. Access to other images can be obtained by toggling through various screen images by pushing a physical button or a touch-screen region corresponding to a button on the electronic shipping label.

Moreover, the electronic shipping label may have numerous fail safes, such as the use of electronic ink (e-ink), which allows the electronic image on the electronic shipping label to remain persistent even without power.

Also disclosed herein is a system for monitoring shipping of a shipping container, a system for locking and unlocking a shipping container, and a modular shipping container. The system for monitoring shipping of a shipping container may include one or more sensors that measure or detect parameters such as temperature, humidity, shock, and orientation with respect to shipping container and a payload area located within the shipping container. The measured or detected parameters may then be received by an electronic device, which may store and transmit the parameters to a web portal for remote access by a user. The user may advantageously view and track the parameters from a remote location to ensure that the payload in the payload area is not damaged during transport.

The system for locking and unlocking a shipping container may include a locking mechanism and an electronic device coupled to the locking mechanism to control the locking mechanism in order to lock and unlock the locking mechanism. The electronic device may receive user input via a display coupled to the electronic device to unlock and unlock the locking mechanism. The user input may include a code or a password made up of alphanumeric characters or symbols. Alternatively, the user input may include biometric information (e.g., fingerprint, face scan, retinal scan) detectable by one or more biometric sensors coupled to the display or the electronic device.

The modular shipping container may include a cavity disposed on an outer surface of a lid or an exterior wall of a base enclosure of the shipping container. The cavity may be configured to house a remote device. The remote device may be a display that can display electronic image files such as shipping labels or data (e.g., temperature, humidity, shock, orientation) measured or detected by one or more sensors positioned within the payload area or on the shipping container. Alternatively, the remote device may be a data logger configured to receive, store, and transmit data from the one or more sensors. The remote device may be received by a tray that can be removably attached to the cavity. The tray may conveniently include wiring to provide the remote device with access to electrical and/or electronic connections. Alternatively, the cavity may be foam and configured to receive the remote device directly. The cavity may have one or more channels extending therefrom to secure wiring. A front surface of the remote device may be flush with the outer surface of the lid or the exterior wall of the base enclosure when the remote device is housed in the cavity so that that the remote device is integrated with the shipping container. Hence, the cavity saves space by integrating the remote device with the shipping container and providing cable management as well as ensures safe attachment of the remote device onto or within the shipping container.

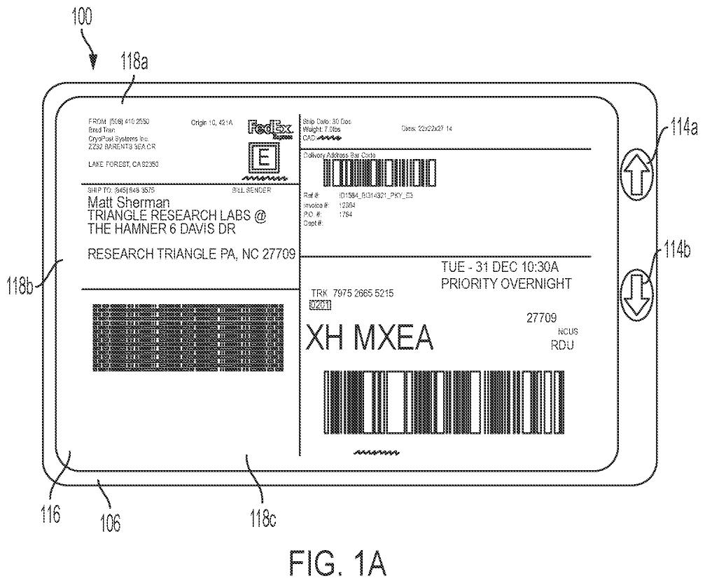

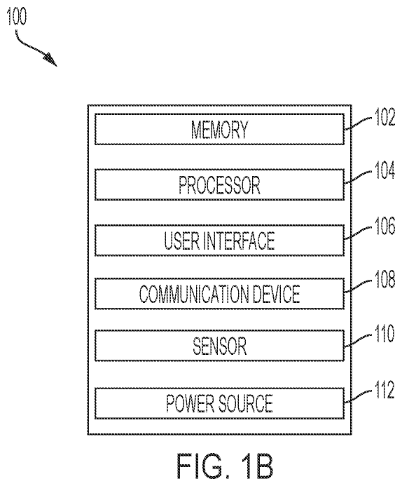

FIG. 1A shows the electronic shipping label 100, and FIG. 1B shows a block diagram of the electronic shipping label 100. The electronic shipping label 100 may be a thin film shipping label and may display any type of shipping label configuration regardless of carrier (i.e. bar-coding, formatting, and carrier specific information required etc.).

The electronic shipping label 100 may be a thin film shipping label with dimensions of approximately 8.5″ wide by 5.5″ tall. The electronic shipping label 100 may be read by humans or by barcode scanner. The electronic shipping label 100 may be mounted on the outside of the shipping box where normal printed shipping labels are placed on the box. The electronic shipping label 100 may be made from a thin flexible plastic sheet and may have a protective clear flexible plastic cover that is not reflective and allows laser scanners to read the electronic shipping label 100. The electronic shipping label 100 may implement e-ink technology, or liquid crystal display technology, or another type of electronic display technology.

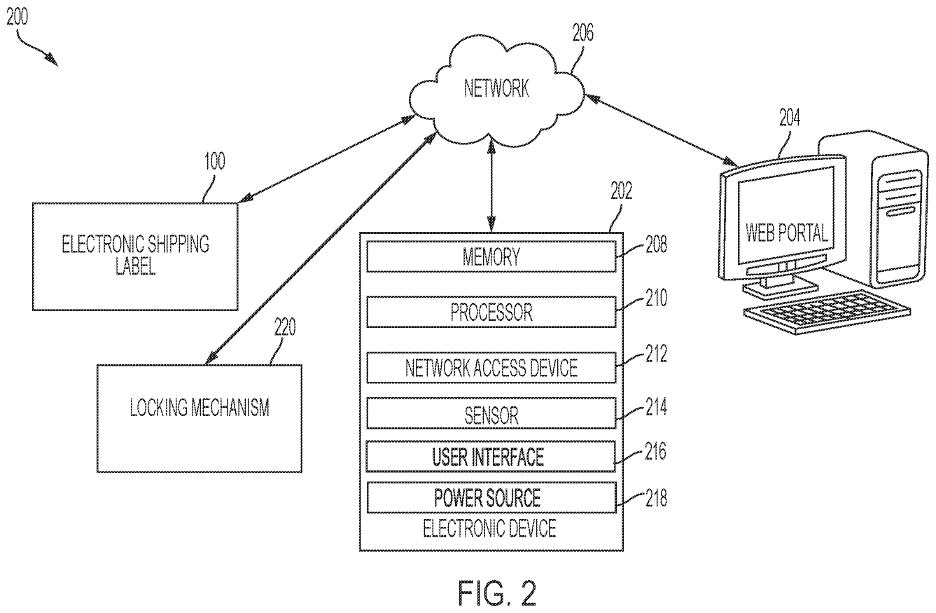

The electronic shipping label 100 includes a memory 102, one or more processors 104, a user interface 106 and/or a communication device 108. The electronic shipping label 100 may have one or more sensors 110 and/or a power source 112. The memory 102 may store one or more electronic image files that are received by the communication device 108. The one or more electronic image files may be obtained from an electronic device 202 (see FIG. 2) via the network 206 (see FIG. 2) and/or via a direct electronic connection between the electronic device 202 and the electronic shipping label 100. Moreover, in various embodiments, the electronic shipping label and the electronic device 202 (see FIG. 2) are integrated together and may share a housing. The memory 102 may be coupled to the one or more processors 104 and store instructions that the one or more processors 104 executes. The memory 102 may include one or more of a Random Access Memory (RAM) or other volatile or non-volatile memory. The memory 102 may be a non-transitory memory or a data storage device, such as a hard disk drive, a solid-state disk drive, a hybrid disk drive, or other appropriate data storage, and may further store machine-readable instructions, which may be loaded and executed by the one or more processors 104. Moreover, the memory 102 may be used to store electronic image files that are associated with the transportation and/or shipment of the shipping container that the electronic shipping label 100 may be affixed to.

The one or more processors 104 may be implemented as a single processor or as multiple processors. The one or more processors 104 may be electrically coupled to the memory 102, the user interface 106, the communication device 108, the one or more sensors 110 and/or the power source 112. The one or more processors 104 may be a controller or a microcontroller specifically designed for retrieving electronic image files and displaying the electronic image files during the transportation or shipment of a shipping container. The one or more electronic image files may include an air-bill, shipping address, sender address, sensor data from the electronic device 202 including temperature data, a bar-code and/or other shipping information for each leg of a shipping itinerary.

The electronic shipping label 100 may have a communication device 108. The communication device 108 may be a network access device. The communication device 108 may include a communication port or channel, such as one or more of a Wi-Fi unit, a Bluetooth® unit, a radio frequency identification (RFID) tag or reader, or a cellular network unit for accessing a cellular network (such as 3G, 4G or 5G). The communication device 108 may transmit data to and receive data from the electronic device 202 (see FIG. 2) and/or the lock mechanism 220 (see FIG. 2). For example, the one or more processors 104 may communicate with the electronic device 202 (see FIG. 2) to obtain the multiple electronic image files and/or sensor data via the network 206 (see FIG. 2) and or a direct electronic connection between the electronic device 202 and the electronic shipping label 100. FIG. 2 further describes the different components from which the electronic shipping label may communicate with using the communication device 108 to obtain multiple electronic image files and/or sensor data.

The electronic shipping label 100 includes a user interface 106. The electronic shipping label 100 may display shipping information, sensor data, notifications and/or other information on the user interface 106. The user interface 106 may include an input/output device that receives user input from a user interface element, a button, a dial, a microphone, a keyboard, or a touch screen. The user interface 106 may have an output device, such as a display 116, a speaker, an audio and/or visual indicator, a touch-screen display, or a refreshable braille display.

The user interface 106 may have a display 116. The display 116 may be used to display one of the one or more electronic image files. The electronic image file may show, for example, a shipping address, a return address, a bar code, a commercial invoice, a hazardous declaration sheet, a certificate of origin and/or other shipment information including loading and unloading instructions. The display 116 may be apportioned into one or more sections 118a-c. The one or more sections 118a-c allow for the electronic shipping label 100 to display multiple electronic image files, simultaneously. For example, in one section, such as the section 118a, the electronic shipping label 100 may display the return address, and in another section, the electronic shipping label 100 may display unloading/loading instructions.

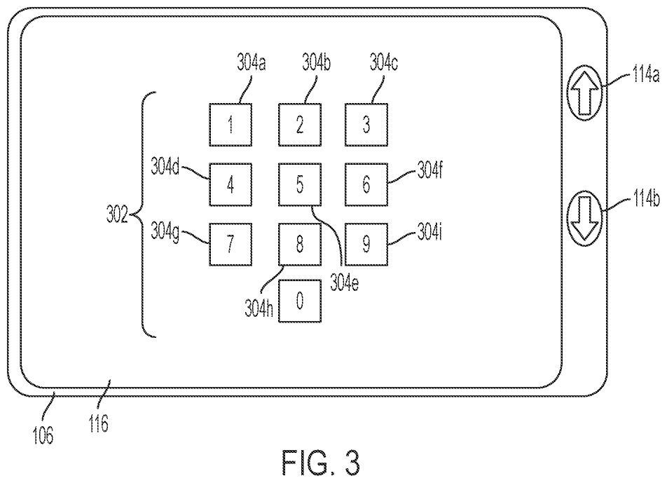

The user interface 106 may include one or more buttons 114a-b. When the user interface 106 receives a selection of one of the one or more buttons 114a-b, the electronic shipping label 100 may switch, toggle, change or otherwise display a different electronic image file on the display 116. The one or more buttons 114a-b may be a physical user interface element in proximity to the display 116 and/or a user interface element on the display 116, such as on a touch-screen display. The electronic shipping label 100 may display multiple user interface elements that when keyed or selected in a sequence may lock or unlock the shipping container, as shown in FIG. 3 for example. With momentary reference to a combination of FIGS. 1A, 1B, 2 and 3, the display 116 may display a keypad 302. The keypad 302 may include multiple user interface elements 304a-j. Each user interface element 304a-j may represent a number on the keypad 302. The user interface 106 may receive one or more selections of the one or more user interface elements 304a-j in an entered sequence when a user depresses the one or more user interface elements 304a-j. The electronic shipping label 100 may compare the entered sequence of the one or more selections of the one or more user interface elements 304a-j with a stored passcode sequence of the one or more user interface elements 304a-j that was previously configured. Such a passcode may be stored in the memory 102 or may be stored remotely in another device, computer, or system accessed via communication device 108. Moreover, the comparing operation may also occur remotely in another device and the electronic shipping label 100 may lock or unlock the shipping container in response to an indication of whether the entered sequence matches the stored passcode sequence.

If the entered sequence matches the passcode sequence, the electronic shipping label 100 may send a signal to a lock mechanism 220 on the shipping container that unlocks the shipping container when the shipping container is in a locked state and/or locks the shipping container when the shipping container is in an unlocked state. That is, the signal switches the state of the lock mechanism 220 from locked to unlocked and/or from unlocked to locked. In some implementations, different sequences of the one or more user interface elements 304a-j may be used to lock or unlock the shipping container. The keypad may be an alphanumeric keypad that includes numbers, letters and/or a combination of both.

Returning reference to FIGS. 1A and 1B, the electronic shipping label 100 may have one or more sensors 110 and/or a power source 112. The one or more sensors 110 may be a temperature sensor that measures temperature within the shipping container, a humidity sensor that measures temperature within the shipping container, a light sensor that measures ambient light and/or other environmental sensor that measures the environmental condition within the shipping container, a shock or vibration sensor that measures acceleration, deceleration, and/or movement, a pressure sensor, a tilt sensor that measures orientation of the shipping container, and any other sensor as desired. The one or more sensors 110 may include a camera, which may take images of the shipping container, to ensure that the shipping container has not been tampered or damaged. The one or more sensors 110 may include a Global Navigation Satellite System (GNSS) receiver such as a GPS receiver.

The electronic shipping label 100 may be a thin film shipping label and may be powered by a power source 112. The power source 112 may be included within the electronic shipping label 100 or may be on the electronic device 202 (see FIG. 2). The power source 112 may be a printed battery, for example, or other non-lithium based power source that allows for safe use during air transport. The electronic shipping label may have a failsafe mode in the event that the power source 112 fails. When the power source 112 fails, the display 116 may remain active and continue to display the last electronic image file that was displayed on the display 116 prior to loss of power.

FIG. 2 shows a block diagram of a shipping and logistics system 200. The shipping and logistics system 200 includes the electronic shipping label 100, the electronic device 202, which may be a smart data logger, and a web portal 204. The shipping and logistics system 200 may also include a lock mechanism 220. The lock mechanism 220 may be a shipper lock mechanism that is positioned on the shipping container and locks, unlocks, or otherwise controls access to the payload or content storage area within the shipping container. The electronic shipping label 100, the electronic device 202, the lock mechanism 220 and/or the web portal 204 may be connected via the network 206. Moreover, the electronic shipping label 100, the lock mechanism 220, and/or the electronic device 202 may be directly interconnected in addition to or in lieu of connection via the network 206. The network 206 may be a local area network (LAN), a wide area network (WAN), a cellular network, the Internet, or combination thereof, that connects, couples and/or otherwise communicates between the different components of the shipping and logistics system 200.

. The electronic device 202 may be a smart data logger. The electronic device 202 may be contained within the shipping container and stay within proximity to the electronic shipping label 100 such that the electronic device 202 stays in communication with the electronic shipping label 100 during transport. In various instances, the electronic device 202 and the electronic shipping label 100 are co-located in a shared housing and may share electronic components. The electronic device 202 may be directly connected to the electronic shipping label 100 such as via a wired or wireless connection. In further instances, the electronic device 202 is not directly connected to the electronic shipping label 100 but is instead connected to the electronic shipping label 100 via the network 206. Moreover, the electronic device 202 communicates with the web portal 204, which monitors each leg of the shipping itinerary. Each leg of the shipping itinerary may have an origin and a destination. The destination of one leg of the shipping itinerary may be the origin of the next leg of the shipping itinerary. The electronic device 202 may periodically or in real-time update the web portal 204 and/or the electronic shipping label 100 with sensor data, monitoring data and/or shipping information.

The electronic device 202 may include a memory 208, one or more processors 210, a communication device 212 and/or a sensor 214. The electronic device 202 may include a user interface 216 and/or a power source 218. The memory 208 may store the shipping itinerary obtained from the web portal 204 and the one or more electronic image files associated with each leg of the shipping itinerary. Moreover, the memory 208 may store instructions executed by the one or more processors 210. The memory 208 may include one or more of a Random Access Memory (RAM) or other volatile or non-volatile memory. The memory 208 may be a non-transitory memory or a data storage device, such as a hard disk drive, a solid-state disk drive, a hybrid disk drive, or other appropriate data storage, and may further store machine-readable instructions, which may be loaded and executed by the one or more processors 210.

In various embodiments, the memory 208 and the memory 102 (see FIG. 1) are the same memory. Moreover, the one or more processors 210 and the processor 104 (see FIG. 1) may be the same processor. Similarly, the communication device 212 and the communication device 108 (see FIG. 1) may be the same communication device. Furthermore, the sensor 214 and the sensor 110 (see FIG. 1) may be the same sensor. Likewise, the user interface 216 and the user interface 106 (see FIG. 1) may be the same user interface. Finally, the power source 218 and the power source 112 (see FIG. 1) may be the same power source.

The user interface 216 may include an input device that receives user input from a user interface element, a scanner, button, a dial, a microphone, or a keyboard but may not have an output device, such as a display, a speaker, an audio and/or visual indicator, a touch-screen display or a refreshable braille display. Instead, the electronic device 202 may use the electronic shipping label 100 as the output device. In further instances, the user interface 216 receives user input by using the electronic shipping label 100 as the input device. The power source 218 may be used to power the electronic device 202 and/or provide power to the electronic shipping label 100.

In some embodiments, the user interface 216 may be provided by the electronic device 202. For example, the user interface 216 may be presented on a touch-screen display of the electronic device 202. The power source 218 may be used to power the electronic device 202 as well as the user interface 216. In some embodiments, the user interface 216 and the electronic device 202 may be powered individually by separate power sources.

The one or more processors 210 may be coupled to the memory 208, the communication device 212, the user interface 216, the power source 218 and/or the sensor 214. The one or more processors 210 may perform functions, such as obtaining the shipping itinerary and the one or more electronic image files from the web portal 204 and providing the one or more electronic image files to the electronic shipping label 100 using the communication device 212, and/or obtaining sensor data to provide to the electronic shipping label 100 and/or the web portal 204. The electronic device 202 may use the one or more sensors 214, such as a temperature sensor to obtain temperature data of the shipping container, and/or a Global Positioning System device to determine a location of the electronic device 202 and/or shipping container. The memory 208, the one or more processors 210, the communication device 212, the user interface 216, the one or more sensors 214 and/or the power source 218 of the electronic device 202 may be the same device or similar device that is similar in structure and/or function as the memory 102 (see FIG. 1), the one or more processors 104 (see FIG. 1), the communication device 108 (see FIG. 1), the user interface 106 (see FIG. 1), the one or more sensors 110 (see FIG. 1) and/or the power source 112 (see FIG. 1) of the electronic shipping label 100, respectively.

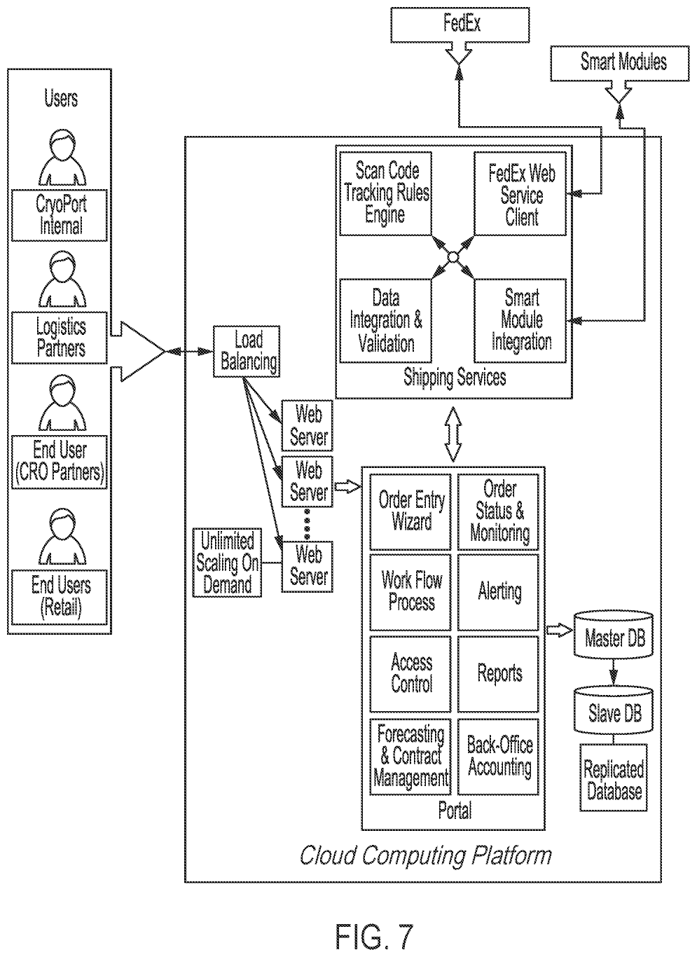

The web portal 204 may generate, receive, or otherwise obtain the shipping itinerary. The web portal 204 may obtain shipping datasets for one or more legs of a shipping itinerary and form the shipping itinerary using the shipping datasets. Once the shipping itinerary is formed, the web portal 204 may generate electronic image files associated with each leg of the shipping itinerary and provide the electronic image files to the electronic device 202 for display on the electronic shipping label 100. Moreover, the web portal 204 may receive data, such as sensor data, from the electronic device 202 and/or electronic shipping label 100 and display the data to the user to allow the user to monitor the shipping container during transit on each leg of the shipping itinerary. FIG. 7 shows a web portal architecture for the web portal 204, which creates the shipping itinerary and/or displays monitoring information of the shipping container during transit.

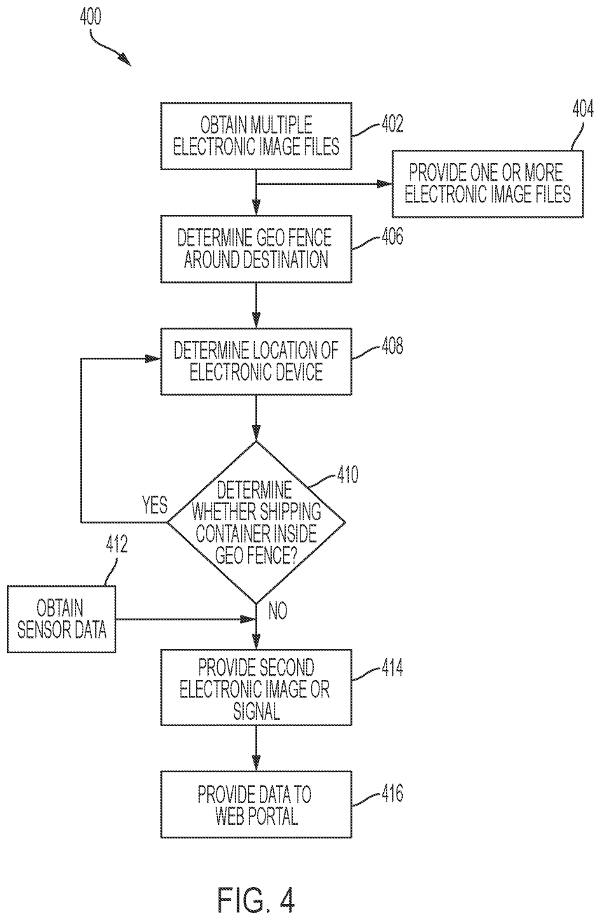

FIG. 4 is a flow diagram of an example process 400 for obtaining and providing electronic images to the electronic shipping label 100. One or more computers or one or more data processing apparatuses, for example, the one or more processors 210 of the electronic device of the shipping and logistics system 200 of FIG. 2, appropriately programmed, may implement the process 400.

Continuing the discussion of FIG. 4 and with periodic reference to aspects of FIGS. 1A-2, the electronic device 202 receives, obtains, or generates multiple electronic image files, which may be stored within the electronic device 202 and/or the electronic shipping label 100 (block 402). The electronic device 202 may obtain a shipping request that includes the shipping itinerary from the web portal 204 via the network 206. A shipper may generate the shipping itinerary using web portal 204. The web portal 204 may receive a shipping request that includes the shipping itinerary and/or other additional information and provide the shipping request to the electronic device 202. The shipping itinerary may be formed from an initial shipping dataset. A shipping dataset may include the sender's information, such as address, name, handling instructions or other contact information, and the receiver's information, such as address, name, or other instructions. The shipping dataset may include other additional information, such as routing information, barcode, air waybill, unloading or loading instructions, transport instructions including an indicator of the direction of orientation of the shipping container, and/or other handling instructions.

The shipping itinerary includes the one or more legs that form the shipping itinerary. Each leg of the shipping itinerary may be associated with a shipping dataset, which includes shipping information, such as a bar code, air waybill or other identifier that provides detailed information about the shipment and allows the shipment to be tracked including a destination address and/or a sender address. One or more electronic images may be associated with a single shipping dataset. For example, one electronic image may display a subset of the shipping dataset that indicates the bar code and/or air waybill, and another electronic image may display another subset of the shipping dataset that indicates the handling instructions.

The electronic device 202 provides one or more electronic image files to the electronic shipping label 100 (block 404). The electronic device 202 may provide all of the one or more electronic image files associated with all the legs of the shipping itinerary to the electronic shipping label 100 so that the electronic shipping label 100 may store the electronic image files in storage. In this manner, the electronic shipping label 100 may retain access to the one or more electronic image files in the event the electronic device 202 is unable to communicate with the electronic shipping label 100. In some implementations, the electronic device 202 may provide only the electronic image file associated with a current leg of the shipping itinerary to minimize resource utilization on the electronic shipping label 100. The electronic image file displays an image of the information within the shipping dataset associated with the electronic image file.

The electronic device 202 may determine or calculate a geo-fence around a destination address associated with a current leg of the shipping itinerary (block 406). The geo-fence around the destination address may be an area that is within a threshold distance of the destination address, such as approximately ½-1 mile. The geo-fence may be used to trigger the electronic device 202 to update the electronic shipping label 100 with the next electronic image file that is associated with the next leg of the shipping itinerary.

The electronic device 202 may determine or detect a location of the electronic device 202 and/or shipping container (block 408). The electronic device 202 may use one or more sensors 214, such as a Global Navigation Satellite System (GNSS) receiver, to determine the location of the electronic device 202. Since the electronic device 202 may be affixed to the shipping container in proximity to the electronic shipping label 100, the location may also identify the location of the shipping container during transport of a leg of the shipping itinerary.

The electronic device 202 may determine whether the shipping container is inside the geo fence (block 410). For instance, the electronic device 202 may determine whether the shipping container is being transported on the next leg of the shipping itinerary. The electronic device may determine that the shipping container is being transported on the next leg of the shipping itinerary when the electronic device 202 exits the geo-fence, such as when the electronic device 202 first enters the geo-fence, stops at the destination address and subsequently exits the geo-fence.

First, the electronic device 202 may determine that the electronic device 202 has entered within the geo-fence, e.g., when the location of the electronic device 202 is within the threshold distance of the destination address. Subsequently, the electronic device 202 may determine that the electronic device 202 has visited the destination address, e.g., when the location of the electronic device is at, near or in proximity to the destination address. Finally, the electronic device may determine that the electronic device 202 has exited the geo-fence when the location of the electronic device 202 exceeds the threshold distance from the destination address.

The electronic device 202 may obtain sensor data using the one or more sensors 214 (block 412). The one or more sensors 214 may include a temperature sensor that measures temperature within the shipping container, a humidity sensor that measures humidity within the shipping container, a light sensor that measures ambient light and/or other environmental sensor that measures the environmental condition within the shipping container, a shock or vibration sensor that measures acceleration, deceleration, and/or movement, a pressure sensor, a tilt sensor that measures orientation of the shipping container, a Global Navigation Satellite System (GNSS) receiver. and any other sensor as desired. The one or more sensors 214 may include a camera, which may take images of the shipping container, to ensure that the shipping container has not been tampered or damaged. The one or more sensors 214 may be the same sensors as the one or more sensors 110 (see FIG. 1B) or may be different sensors. Moreover, the electronic device 202 and/or the electronic shipping label 100 (see FIG. 1B) may share a single set of sensors, so that either device omits one or more sensor and utilizes a sensor associated with the other device.

The electronic device 202 provides another electronic image file or signals the electronic shipping label to change to the next electronic image file to update the display of the electronic shipping label (block 414). The electronic device 202 may provide the other electronic image file or signal the electronic shipping label to change to the other electronic image file in response to the electronic device 202 determining that the shipping container has exited the geo-fence or when the electronic device 202 receives or obtains the other electronic image file from user input, such as a scan of a shipping dataset, or from the web portal 204 in response to the electronic device 202 signaling to the web portal 204 that the electronic device 202 has exited the geo-fence, for example.

The electronic image file may be associated with the next leg of the shipping itinerary, which may show a different shipping dataset than the electronic image file associated with the current leg of the shipping itinerary. In some implementations, the electronic device provides an electronic image file that is generated based on the sensor data. The electronic image file may show statistics, such as the temperature, humidity, or other environmental factors of the current state of the shipping container or image of the shipping container. The electronic device 202 may send or otherwise transmit a signal to the electronic shipping label 100 to toggle to the next electronic image file, which may be associated with the next leg of the shipping container.

The electronic device 202 may also update the web portal 204 with the sensor data and/or status, e.g., location of the shipping container (block 416). The electronic device 202 may provide the sensor data including temperature, humidity, or other environmental factors of the shipping container and/or the image of the shipping container to the web portal 204 so that a user may view and monitor status of the shipping container during transit.

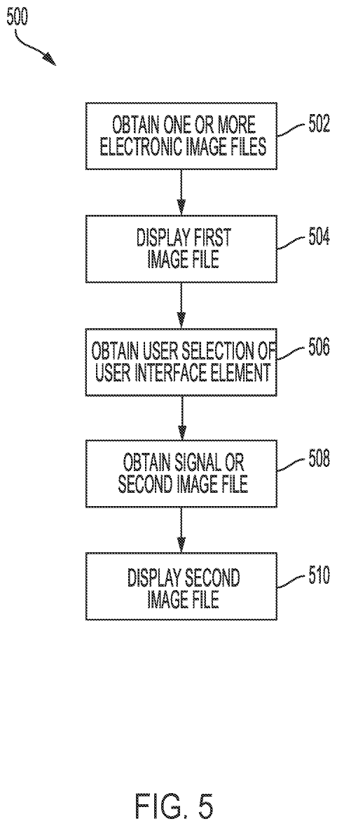

FIG. 5 is a flow diagram of an example process 500 for displaying shipping information on the electronic shipping label 100. One or more computers or one or more data processing apparatuses, for example, the one or more processors 104 of the electronic shipping label 100 of the shipping and logistics system 200 of FIG. 2, appropriately programmed, may implement the process 500. The following discussion of aspects of FIG. 5 also will include periodic reference to aspects of FIGS. 1A-2.

The electronic shipping label 100 obtains the one or more electronic image files (block 502). The electronic shipping label 100 may obtain the one or more electronic image files from the electronic device 202 or another device. The electronic image file may include the shipping dataset associated with a leg of the shipping itinerary. The electronic shipping label may obtain the one or more electronic image files and store the one or more electronic image files in the memory 102. The one or more electronic image files may be ordered such that the first electronic image is associated with the first leg of the shipping itinerary and the subsequent legs are ordered in the order of the different legs of the shipping itinerary. The one or more electronic image files may not be ordered but rather have an identifier that indicates the corresponding leg of the shipping itinerary that the electronic image file is associated with. As the shipping container traverses through the shipping itinerary, the electronic shipping label 100 may receive an electronic image file for display and/or may receive a signal that includes the identifier, which triggers display of the electronic image file that corresponds with the identifier.

In some implementations, the one or more electronic image files may be associated with sensor data, such as orientation, ambient temperature, ambient pressure, ambient humidity, ambient lighting, shock or other related environmental factors within the shipping container, or other additional information, such as unloading/loading instructions, warning labels, or an invoice. These electronic image files may similarly be ordered in sequence among the one or more electronic image files.

The electronic shipping label 100 displays the electronic image file (block 504). One or more electronic image files may be associated with each leg of the shipping itinerary. If there are multiple electronic image files associated with the leg of the shipping itinerary, the electronic shipping label 100 may display the multiple electronic image files in different sections of the display 116. In some implementations, the electronic image file may be associated with other information, such as the sensor data or other shipping information.

The electronic shipping label 100 may obtain a user selection of one or more user interface elements (block 506). The user selection of the one or more user interface elements may be an actuating of a physical button on the electronic shipping label 100 and/or a user interface element displayed on a touch-screen display of the electronic shipping label 100. The actuation of the physical button and/or the user interface element may signal the electronic shipping label 100 to toggle to the next electronic image file in an ordered sequence of the multiple electronic image files.

The electronic shipping label 100 obtains the signal or a second electronic image file (block 508). The electronic shipping label 100 may obtain the signal or the second electronic image file from the electronic device 202, be triggered by user input, such as the actuating of a button, or be triggered by a timer, such as after a threshold amount of time has elapsed. The signal may indicate to the electronic shipping label 100 that the electronic device 202 has exited the geo-fence surrounding the destination location of a leg of the shipping itinerary, a threshold amount of time has elapsed or that a user has actuated a button to toggle through the multiple electronic image files. When the electronic shipping label 100 receives the second electronic image file, this may indicate to the electronic shipping label 100 that the electronic device 202 has exited the geo-fence surrounding the destination location of a leg of the shipping itinerary.

The electronic shipping label 100 displays the second electronic image file (block 510). When the electronic shipping label 100 receives the signal or the second electronic image file from the electronic device 202, the electronic shipping label 100, in response, may update the first electronic image file with the second electronic image file. This allows for the display 116 of the electronic shipping label 100 to be updated with the new information in the second electronic image file, such as the shipping dataset for the next leg of the shipping itinerary, sensor data, and/or other shipping information, such as handling/loading instructions. In some implementations, the electronic shipping label 100 switches to the second electronic image file in response to receiving an actuation of a button that toggles through the multiple electronic image files.

When the electronic shipping label 100 displays the second electronic image file and the second electronic image file is not displaying the shipping data for the leg of the shipping itinerary, the electronic shipping label 100 may switch back to an electronic image file that shows the shipping dataset for the leg of the shipping itinerary after a threshold amount of time, such as approximately 30 seconds. This ensures that an electronic image file that shows the shipping dataset for the current leg of the shipping itinerary is displayed during transit.

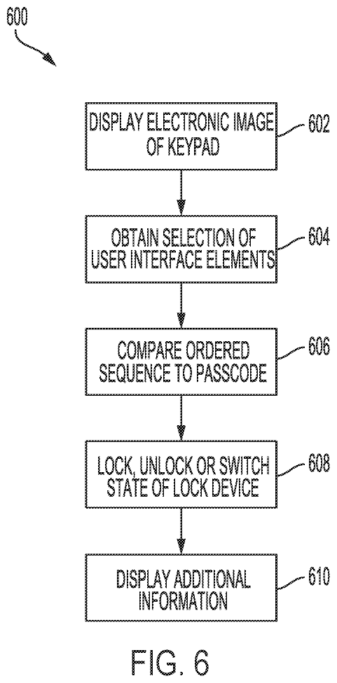

FIG. 6 is a flow diagram of an example process 600 for accessing the shipping container through the electronic shipping label 100. One or more computers or one or more data processing apparatuses, for example, the one or more processors 104 of the electronic shipping label 100 of the shipping and logistics system 200 of FIG. 2, appropriately programmed, may implement the process 600. The following discussion of aspects of FIG. 6 also will include periodic reference to aspects of FIGS. 2 and 3.

The electronic shipping label 100 displays an electronic image file on the display 116 that includes a keypad 302 (block 602). The keypad 302 has multiple user interface elements 304a-j, and each user interface element 304a-j may be sensitive to touch and associated with an identifier, such as an alphanumeric value. The multiple user interface elements 304a-j may be arranged as a number pad, a conventional keyboard or in any other arrangement.

The electronic shipping label 100 obtains a selection of one or more of the multiple user interface elements 304a-j in an entered sequence (block 604). When a user touches, depresses or otherwise interacts with one of the multiple user interface elements 304a-j, the electronic shipping label 100 stores the entered sequence of identifiers and the order in which the identifiers are entered.

The electronic shipping label 100 compares the entered sequence of the selection of the one or more of the multiple user interface elements 304a-j to a passcode sequence (block 606). The passcode sequence is an ordered sequence of a pre-configured or pre-stored user configured sequence of identifiers that authenticates an entered sequence to switch the state of a lock mechanism to access or lock the shipping container. In various embodiment, the comparing is a locally executed comparison within the memory of the electronic shipping label 100. In further embodiments, the comparing is a remotely executed or an at least partially remotely executed process utilizing the network 206 so that the passcode sequence is not retained in the electronic shipping label 100 but is retained at a separate location.

The electronic shipping label 100 locks, unlocks or switches the state of the lock mechanism to allow or deny access to the shipping container based on the comparison (block 608). If the entered sequence of the selections matches the passcode sequence, the electronic shipping label 100 may unlock the lock mechanism 220, e.g., by sending a signal to the lock mechanism 220, to allow access to the shipping container. In some implementations, when the entered sequence of the selections matches the passcode sequence, the electronic shipping label 100 may switch the state of the lock mechanism 220, e.g., from lock to unlock or unlock to lock. If the entered sequence of the selections does not match the passcode sequence, the electronic shipping label may display a failure notification on the display 116 or otherwise notify the user.

The electronic shipping label 100 may display additional information when the state of the lock mechanism 220 changes (block 610). For example, when the lock mechanism 220 is switched from a locked state to an unlocked state, the electronic shipping label 100 may display additional information, such as loading/unloading information, in response to the switch in states. In another example, when the lock mechanism 220 is switched from an unlocked state to a locked state, the electronic shipping label 100 may display an electronic image file with the next set of shipping data including next destination location, sensor data or other shipping information, such as a “handle with care” notification.

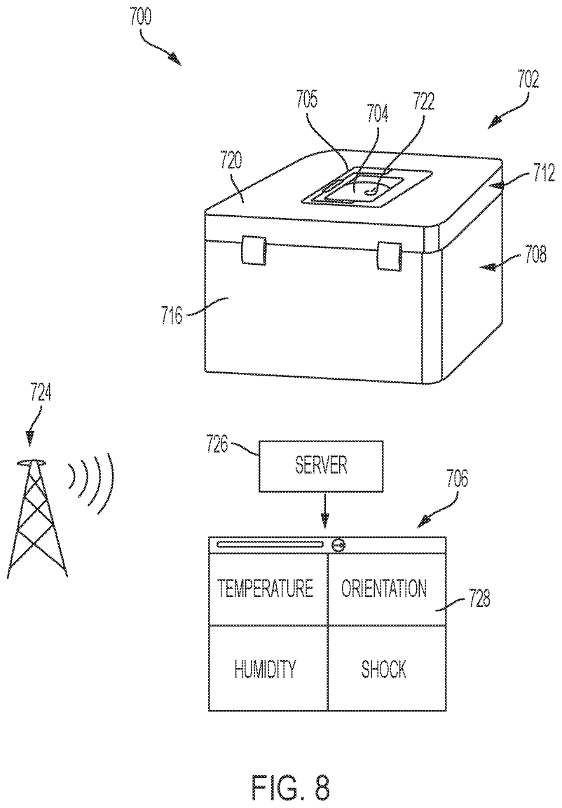

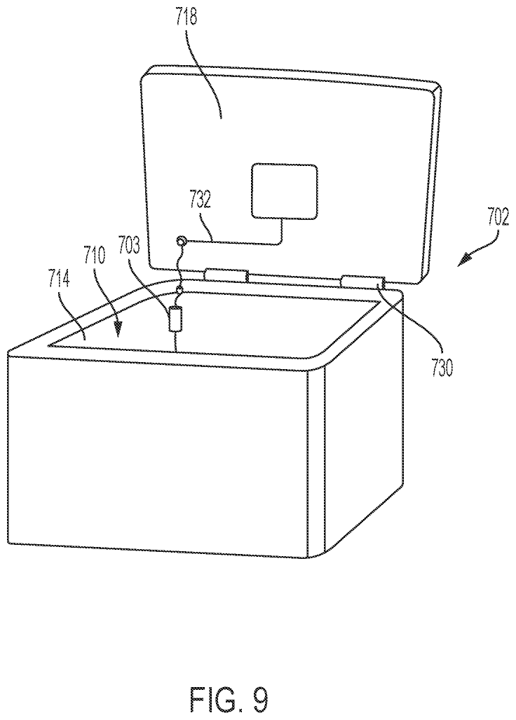

FIGS. 8 and 9 show a system 700 for monitoring shipping of a shipping container 702. The system 700 may include the shipping container 702, one or more sensors 703, an electronic device 704, and a web portal 706. In various embodiments, the one or more sensors 703 are the one or more sensors 214 (see FIG. 2) and/or are the one or more sensors 110 (see FIG. 1B). In various embodiments, the electronic device 704 is the electronic device 202 (see FIG. 2). In various embodiments, the electronic device 704 is the electronic shipping label 100. In various embodiments, the web portal 706 is the web portal 204 (see FIG. 2).

The shipping container 702 may include a base enclosure 708. The base enclosure 708 may have a payload area 710. The payload area 710 may receive a payload and maintain a temperature of an environment surrounding the payload. The temperature may be maintained by using a cryogenic material (e.g., liquid nitrogen, liquid oxygen, carbon dioxide) and/or a phase-change material (e.g., ice, dry ice). In some embodiments, exposure of the payload area 710 to the cryogenic material may be controlled remotely and/or automatically. The base enclosure 708 may be enclosed by a lid 712 coupled to the base enclosure 708. The lid 712 may be capable of opening and closing. The shipping container 702 may have a hardened exterior that can withstand shock and shear forces. The hardened exterior may improve the durability of the shipping container 702 and mitigate or prevent physical damage to the payload. In some embodiments, the shipping container 702 may be water resistant or waterproof. The shipping container 702 may have a cuboid or a cylindrical shape. In some embodiments, the shipping container 702 may be a dewar.

The one or more sensors 703 may measure or detect at least one parameter associated with the shipping container 702. For example, the at least one parameter may be shock endured by the shipping container 702 measured or detected by a shock sensor and/or the orientation of the shipping container 702 measured or detected by tilt sensor. In such embodiments, the one or more sensors 703 may be positioned on the shipping container 702, on the exterior of the shipping container 702, or under an exterior surface of the shipping container 702. For example, the one or more sensors 703 may be on the base enclosure 708 and/or the lid 712, embedded between an inner wall 714 and an outer wall 716 of the base enclosure 708, or embedded between an inner surface 718 and an outer surface 720 of the lid 712. In other examples, the at least one parameter may be temperature within the payload area 710 measured by a temperature sensor and/or humidity measured by a humidity sensor. In such embodiments, the one or more sensors 703 may be positioned within the payload area 710. For example, the one or more sensors 703 may be attached to the inner wall 714 or the inner surface 718. In some embodiments, the one or more sensors 703 may have the specifications of the sensors 110 (see FIG. 1B) and/or the sensors 214 (see FIG. 2). The one or more sensors 703 may be coupled to and in communication with the electronic device 704. The communication may be a wired or a wireless (e.g., Bluetooth®, Wi-Fi®, infrared, cellular) connection.

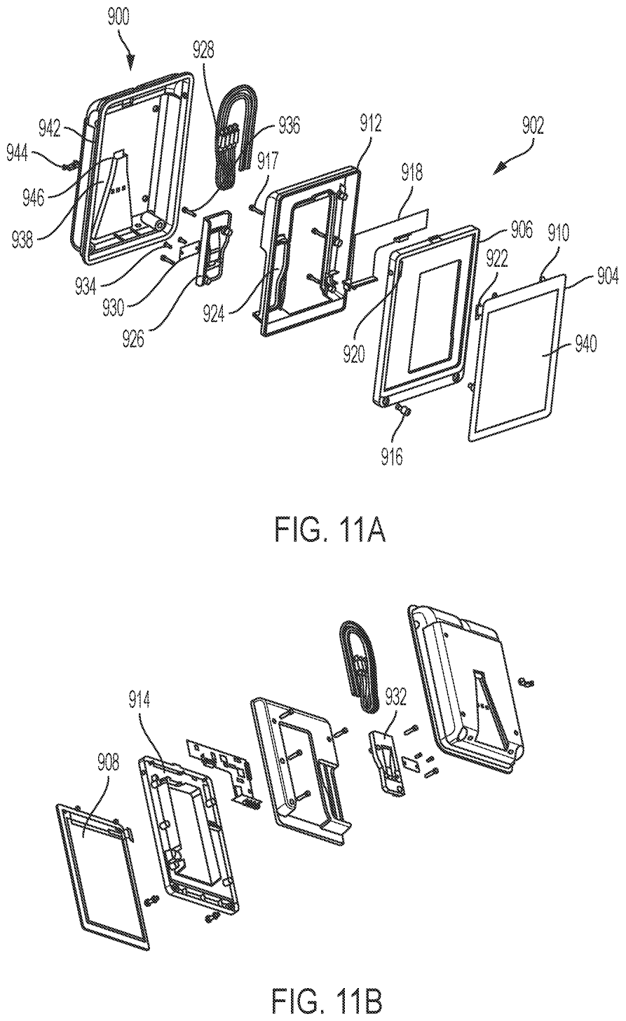

The electronic device 704 may include one or more components of the electronic shipping label 100 (see FIG. 1B). For example, the electronic device 704 may have a memory, a processor, a user interface, a communication device, and a power source having the same specifications of the memory 102, the processor 104, the user interface 106, the communication device 108, and the power source 112, respectively. The electronic device 704 may have a power button 722 to turn on and turn off the electronic device 704. In some embodiments, the electronic device 704 may be a data logger. In some embodiments, the electronic device 704 may be a remote device that is removably attached to the shipping container 702, which will be further explained in discussing FIGS. 11A-15. In some embodiments, the electronic device 704 may be an integrated component of the shipping container 702 that is not detachable from the shipping container 702. The electronic device 704 may receive the at least one parameter from the one or more sensors 703 via the communication device. The electronic device 704 may store the at least one parameter via the memory. The electronic device 704 may transmit the at least one parameter to the web portal 706 via the communication device. In some embodiments, the transmission may occur via a cellular connection. Hence, the electronic device 704 may include a SIM card to hold information and allow connection with a cellular network. The communication device of the electronic device 704 may transmit the at least one parameter in signal form to a cell tower 724. The cell tower 724 may then communicate with a server 726 hosting the web portal 706 to transmit the at least one parameter to the server 726.

The web portal 706 may display the received at least one parameter on a user interface 728. The user interface 728 may have sections, tabs, windows, or pages where each section, tab, window, or page displays a parameter of the at least one parameter. For example, the user interface 728 may display temperature, orientation, humidity, and shock. The user interface 728 may display the at least one parameter in real-time and store the at least one parameter from the past on the server 726 for viewing. The at least one parameter may be stored and viewed per second, minute, hour, day, week, etc. throughout the duration of transport. The web portal 706 may compile the received at least one parameter over a desired time duration within the duration of transport or the entire duration of transport and generate one or more trend graphs (e.g., line graphs, bar graphs) to be displayed on the user interface 728. The web portal 706 may be accessible on any device having an internet connection and a web browser. In some embodiments, the web portal 706 may be embodied in a mobile operating system application. The user interface 728 may be navigated using a mouse, a keyboard, touchscreen, and/or the like based on the features of the device that the user interface 728 is being displayed on. In some embodiments, the web portal 706 may have the specifications of the web portal 204 (see FIG. 2).

FIG. 9 shows a perspective view of the shipping container 702 in an open configuration according to an aspect of the disclosure. The lid 712 is positioned to allow access to the payload area 710. The lid 712 may be attached to the base enclosure 708 with hinges 730 that enables the lid 712 to be opened and closed as shown in FIG. 9. In some embodiments, the lid 712 may be entirely detached from the base enclosure 708 or may slide over the base enclosure 708 to be opened and closed.

In embodiments where the communication between the one or more sensors 703 and the electronic device is not wireless, the one or more sensors 703 may be electronically coupled to the electronic device 704 with the wiring 732. In some embodiments, the wiring 732 may be unplugged to fully open the shipping container 702. The wiring 732 may be managed by concealing the wiring 732 within or through holes, grooves, or channels of the shipping container 702 as well as using conventional cable management tools, such as zip ties.

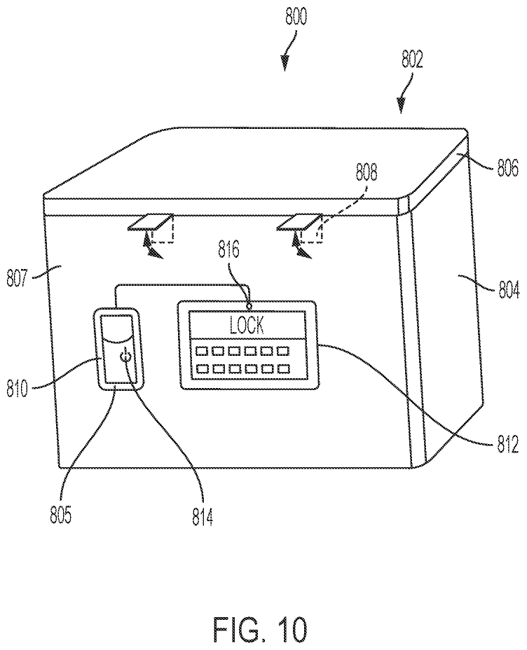

FIG. 10 shows a perspective view of a system 800 for locking and unlocking a shipping container 802. The shipping container 802 may be the shipping container 702 (see FIG. 9) The shipping container 802 may include a base enclosure 804. The base enclosure 804 may have a payload area having the same specifications of the payload area 710 (see FIG. 9). The payload area may receive a payload and maintain a temperature of an environment surrounding the payload. The temperature may be maintained by using a cryogenic material (e.g., liquid nitrogen, liquid oxygen, carbon dioxide) or a phase-change material (e.g., ice, dry ice). In some embodiments, exposure of the payload area to the cryogenic material may be controlled remotely and/or automatically. The base enclosure 804 may be enclosed by a lid 806 coupled to the base enclosure 804. The lid 806 may be capable of opening and closing. The shipping container 802 may have a hardened exterior that can withstand shock and shear forces. The hardened exterior may improve the durability of the shipping container 802 and mitigate or prevent physical damage to the payload. In some embodiments, the shipping container 802 may be water resistant or waterproof. The shipping container 802 may have a cuboid or a cylindrical shape. In some embodiments, the shipping container 802 may be a dewar.

The system 800 may include a locking mechanism 808, an electronic device 810, and a display 812. The locking mechanism 808 may be the locking mechanism 220 (see FIG. 2). The electronic device 810 may be the electronic device 704 (see FIG. 9), the electronic device 202 (see FIG. 2) and/or the electronic shipping label 100 (see FIG. 1B). The locking mechanism 808 may provide access to the payload area in an unlocked configuration and prevent access to the payload area in a locked configuration. For example, the locking mechanism 808 may include one or more latches that secures the lid 806 (e.g., lid 712 of FIG. 9) over the base enclosure 804 (e.g., base enclosure 708 of FIG. 9) as shown in FIG. 10. In another example, the locking mechanism 808 may include a hook and clasp engagement. In yet another example, the locking mechanism 808 may include a barrel lock. The locking mechanism 808 may be controlled with the electronic device 810 to switch the locking mechanism 808 between the unlocked configuration and the locked configuration.

The electronic device 810 may be coupled to or in electronic communication with the locking mechanism 808. The electronic communication may be wired or wireless (e.g., Bluetooth®, Wi-Fi®, infrared, cellular). The locking mechanism 808 may include a motor, which the electronic device 810 may send a signal to in order to actuate. The electronic device 810 may include one or more components of the electronic shipping label 100 (see FIG. 1B). For example, the electronic device 810 may have a memory, a processor, a user interface, a communication device, and a power source having the same specifications of the memory 102, the processor 104, the user interface 106, the communication device 108, and the power source 112, respectively. In some embodiments, the electronic device 810 may have the specifications of the electronic device 704 and/or electronic devices 202 (see FIG. 2). The electronic device 810 may have a power button 814 to turn on and turn off the electronic device 810. In some embodiments, the electronic device 810 may be a data logger. In some embodiments, the electronic device 810 may be a remote device that is removably attached to the shipping container 802, which will be further explained in discussing FIGS. 11A-15. In some embodiments, the electronic device 810 may be a native component of the shipping container 802 that is not detachable from the shipping container 802. The electronic device 810 may control the locking mechanism 808 based on user input.

The user input may be received by the display 812 coupled to or in electronic communication with the electronic device 810. Display 812 may be an aspect of or the same as user interface 216 (see FIG. 2) or user interface 106 (see FIG. 1B). The electronic communication may be wired or wireless (e.g., Bluetooth®, Wi-Fi®, infrared, cellular). The display 812 may communicate the received user input to the electronic device 810. The user input may be a selection between the unlocked configuration and the locked configuration. The user input may include a code or a password. In some embodiments, prior to prompting an option to choose the unlocked configuration, the display 812 may prompt for the code or the password. In some embodiments, the display 812 may prompt for the code or the password after choosing the unlocked configuration. The code or the password may include alphanumeric characters or symbols.

The display 812 may be touchscreen. In some embodiments, the display 812 may be an e-ink display. The code or the password may be entered using one or more fingers or a stylus. For example, a virtual keyboard or keypad may be displayed on the touchscreen display 812, and a user may press keys of the virtual keyboard or the keypad to enter the code or the password. In some embodiments, the user may be prompted to draw a shape or connect a series of dots in a particular sequence instead of the code or the password. In some embodiments, a biometric sensor 816 may be coupled to the display 812. The biometric sensor 816 may detect user input in the form of biometric information. The biometric sensor 816 may be a camera, a fingerprint sensor, or a microphone by example. The biometric sensor 816 may be capable of facial recognition, fingerprint recognition, voice recognition, retina scan, iris recognition, keystroke dynamic recognition, or signature recognition by example. The memory of the electronic device 810 may store authentication information to authenticate the code, the password, or any other security credential.

Once the processor of the electronic device 810 completes authentication, the electronic device 810 may display a notification of successful authentication on the display 812. The electronic device 810 may also send a signal to actuate the motor of the locking mechanism 808 to place the locking mechanism 808 in the unlocked configuration. In the unlocked configuration, the lid 806 may be free to move and the shipping container 802 may be opened or closed.

The display 812 may perform additional tasks, such as display one or more electronic image files associated with one or more legs of a shipping itinerary (see FIG. 1) or data measured or detected by one or more sensors 703 positioned within the payload area 710 (see FIG. 9). The electronic image files and/or the data may be stored in the memory of the electronic device 810.

FIG. 11A and FIG. 11B each show an exploded view of a tray 900 configured to receive a remote device 902 and be removably attached to a shipping container. The shipping container may be the shipping container 702 (see FIG. 8) or the shipping container 802 (see FIG. 10). In some embodiments, the remote device 902 may be housed in a cavity 705 defined by the outer surface 720 of the lid 712 along with the tray 900 (see FIG. 8). In some embodiments, the remote device 902 may be housed in a cavity 805 defined by an exterior wall 807 of the base enclosure 804 (see FIG. 10). The remote device 902 may be the electronic device 704, 810, the display 812, or another mobile device, such as a data logger. The remote device 902 shown in FIG. 11A is a display, which may be an e-ink display, by example.

The remote device 902 may have a screen 904. The screen 904 may be an aspect of or the same as the display 812 (see FIG. 10), the user interface 216 (see FIG. 2), or the user interface 106 (see FIG. 1B). The screen 904 may be attached to a backing 906 with a back surface 908 of the screen 904 facing towards the backing 906. The attachment may be facilitated by conventional fasteners such as the clips 910 shown in FIG. 11A, screws, and/or the like. The backing 906 may be attached to a case 912 with a back surface 914 of the backing 906 facing towards the case 912. The attachment may be facilitated by conventional fasteners, such as the screws 917 shown in FIG. 11A, clips, and/or the like. The backing 906 may be further attached to the tray 900 via conventional fasteners, such as the screws 916. Between the backing 906 and the case 912 may be a processor 918. The processor 918 may have the same specifications of the processor 104 (see FIG. 1B) and/or processor 210 (see FIG. 2). The screen 904 may be coupled to or in electronic communication with the processor 918. The backing 906 may have a hole 920 to create a path for the wiring 922 of the screen 904 to connect to the processor 918.

The case 912 may have a slot 924. The slot 924 may receive a cable holder 926. The cable holder 926 may securely hold and organize one or more cables 928. In some embodiments, the cables 928 may connect one or more sensors located on or within the shipping container, such as the one or more sensors 110 (see FIG. 1B), the one or more sensors 214 (see FIG. 2), or the one or more sensors 703 (see FIG. 9), to the processor 918. In some embodiments, the cables 928 may connect an electronic device, such as the electronic device 810 (see FIG. 10), to the processor 918. The cable holder 926 may have a backplate 930 attachment to retain the cables 928 from a rear 932 of the cable holder 926. The backplate 930 may be attached to the cable holder 926 via conventional fasteners, such as the screws 934. The cable holder 926 may be attached to the case 912 or the backing 906 via conventional fasteners, such as clips or the screws 936. The tray 900 may have a hole 946 to guide the cables 928 out of the tray 900.

The tray 900 may have a housing 938 configured to receive the remote device 902. The remote device 902 may be securely attached to the housing 938 such that a front surface 940 of the screen 904 capable of displaying picture is visible and facing away from the tray 900. The housing 938 may conform to the shape of the remote device 902. The screen 904 may be flush with outer edges 942 of the tray 900 when the remote device 902 is housed by the housing 938. In some embodiments, the remote device 902 may be attached to the housing 938 via snap-fitment. The tray 900 may be attached to the cavity 705, 805 via conventional fasteners, such as the fastener 944. The front surface 940 of the remote device 902 may be flush with the outer surface 720 of the lid 712 when the remote device 902 is housed in the cavity 705 (see FIG. 8) or the exterior wall 807 of the base enclosure 804 when the remote device 902 is housed in the cavity 805 (see FIG. 10).

The tray 900 may be molded from plastic. In some embodiments, the tray 900 may be metal or wood. The tray 900 may have a unitary structure or have multiple parts. The tray 900 may have a hardness that can protect the remote device 902 from physical damage. In some embodiments, the tray 900 may be coated with a coating material (e.g., epoxy, polyurethane) for improved durability.

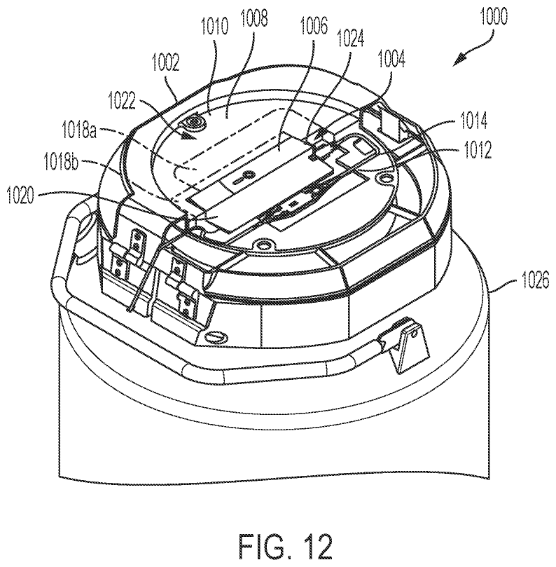

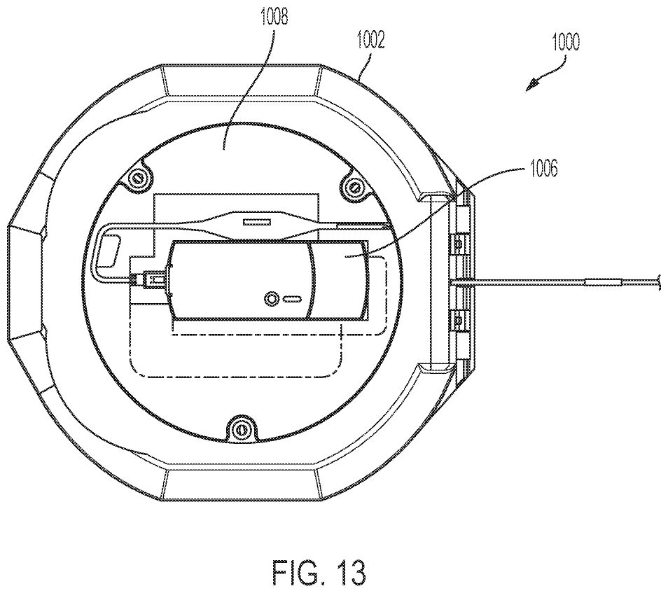

FIG. 12 shows a perspective view of a lid 1002 of the dewar 1000, and FIG. 13 shows a top view of the dewar 1000. The lid 1002 may have a cavity 1004 to house a remote device 1006. The remote device 1006 may be the electronic device 704 (see FIG. 8), 810 (see FIG. 10), the display 812 (see FIG. 10), or another device. FIG. 12 shows a data logger as the remote device 1006 by example. The cavity 1004 may be defined by an insert 1008. The insert 1008 may be inserted within a recess 1010 defined by the lid 1002. The recess 1010 may be shaped and sized so that the recess 1010 conforms to the shape of the insert 1008 and the insert 1008 fits within the recess 1010 in a snug fashion. In some embodiments, the insert 1008 may be fastened to the recess 1010 via conventional fasteners, such as screws or adhesives.

A front surface 1020 of the remote device 1006 may be flush with an outer surface 1022 of the insert 1008 when the remote device 1006 is housed by the cavity 1004. The remote device 1006 may directly contact one or more walls 1024 of the cavity 1004.

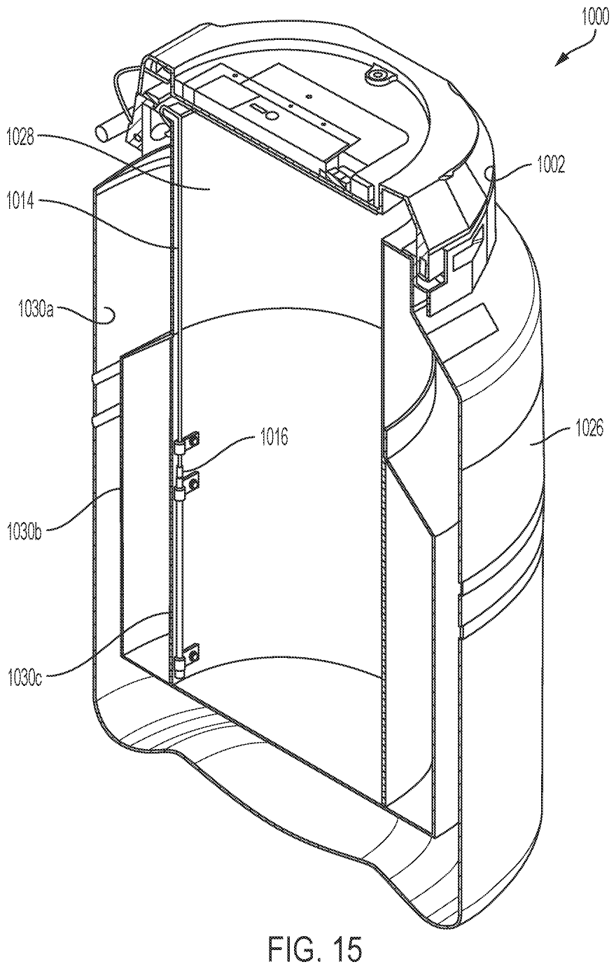

The insert 1008 may have one or more channels 1012 or grooves extending from the cavity 1004. The one or more channels 1012 may secure wiring 1014 to electronically couple the remote device 1006 to one or more sensors 1016 (see FIG. 15). In embodiments where the remote device 1006 is the display 812, the wiring 1014 may electronically couple the remote device 1006 to a data logger.

In some embodiments, the insert 1008 may have a unitary structure. In some embodiments, the insert 1008 may have multiple removable pieces 1018a, 1018b to accommodate the reception of remote devices of different sizes and/or shapes. The removable pieces 1018a, 1018b may have different sizes and/or shapes.

The lid 1002 may be opened and closed over the base enclosure 1026. The lid 1002 may be twisted, slid, lifted, and/or the like to be opened. In some embodiments, the lid 1002 may be attached to the base enclosure 1026 via hinges.

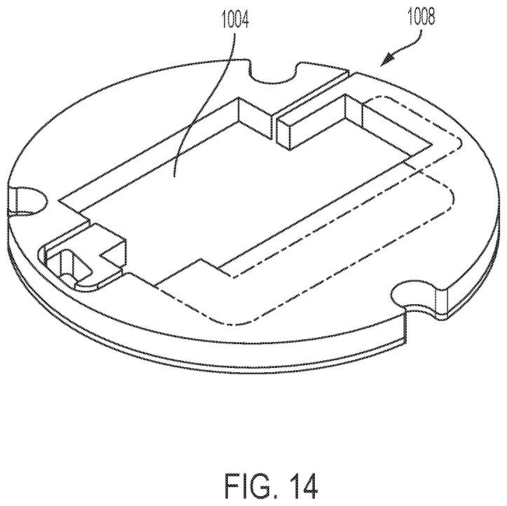

FIG. 14 shows an isolated view of the insert 1008 defining the cavity 1004. The insert 1008 may have a circular shape by example. In other examples, the insert 1008 may be any other shape. In some embodiments, the shape may conform to or complement the shape of the lid 1002. The insert 1008 may be plastic, metal, or wood by example. In the embodiment shown in FIG. 14, the insert 1008 is foam. The foam may be synthetic or natural (e.g., derived from sea sponges).

FIG. 15 shows a cross-sectional view of the dewar 1000. The dewar 1000 may have a cylindrical shape. The base enclosure 1026 may have a payload area 1028. The payload area 1028 may receive a payload and maintain a temperature of an environment surrounding the payload. The temperature may be maintained by using a cryogenic material (e.g., liquid nitrogen, liquid oxygen, carbon dioxide) or a phase-change material (e.g., ice, dry ice). In some embodiments, exposure of the payload area 1028 to the cryogenic material may be controlled remotely and/or automatically.

The one or more sensors 1016 may be located within the payload area 1028 as shown in FIG. 15. In other embodiments, the one or more sensors 1016 may be located on the exterior of the dewar 1000 or within walls 1030a-c and/or layers of the base enclosure 1026. The one or more sensors 1016 may have the same specifications as the one or more sensors 110 (see FIG. 1B), the one or more sensors 214 (see FIG. 2), or the one or more sensors 703 (see FIG. 9). The one or more sensors 1016 may measure or detect parameters such as temperature, humidity, shock, and/or orientation. For example, one of the one or more sensors 1016 may be a thermocouple. The one or more sensors 1016 be in electronic communication with the remote device 1006 via a wired or a wireless (e.g., Bluetooth®, Wi-Fi®, infrared, cellular) connection. In embodiments where the communication between the one or more sensors 1016 and the remote device 1006 is not wireless, the one or more sensors 1016 may be electronically coupled to the remote device 1006 with the wiring 1014. The wiring 1014 may be extended through a hole in the lid 1002 down to the payload area 1028. In some embodiments, the wiring 1014 may be unplugged to fully open the dewar 1000. The wiring 1014 may be managed by concealing the wiring 1014 within or through holes, grooves, or channels of the dewar 1000 as well as using conventional cable management tools, such as zip ties.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for monitoring shipping of a shipping container, comprising:
one or more sensors positioned on or within the shipping container, the one or more sensors configured to measure or detect at least one parameter associated with the shipping container;
an electronic device in communication with the one or more sensors, the electronic device configured to receive, store, and transmit the at least one parameter from the one or more sensors; and
a web portal in communication with the electronic device, the web portal configured to receive the at least one parameter from the electronic device and display the at least one parameter on a user interface.

2. The system of claim 1, wherein the one or more sensors are positioned within a payload area of the shipping container, the payload area configured to receive a payload and maintain a temperature of an environment surrounding the payload, the at least one parameter being at least one of humidity and temperature within the payload area.

3. The system of claim 1, wherein the at least one parameter is at least one of shock endured by the shipping container or an orientation of the shipping container.

4. The system of claim 1, wherein the electronic device and the web portal communicate via a cellular connection.

5. The system of claim 1, wherein the electronic device is a remote device configured to be removably attached to the shipping container.

6. A system for locking and unlocking a shipping container, comprising:
a locking mechanism configured to provide access to a payload area of the shipping container in an unlocked configuration and prevent access to the payload area in a locked configuration;
an electronic device coupled to the locking mechanism, the electronic device configured to control the locking mechanism to switch the locking mechanism between the unlocked configuration and the locked configuration based on user input; and
a display coupled to the electronic device, the display configured to receive the user input and communicate the user input to the electronic device, the user input being a selection between the unlocked configuration and the locked configuration.

7. The system of claim 6, wherein the user input includes a code or a password comprising alphanumeric characters or symbols.

8. The system of claim 6, further comprising a biometric sensor coupled to the display, the biometric sensor configured to detect biometric information, wherein the user input includes the biometric information.

9. The system of claim 6, wherein the locking mechanism comprises one or more latches configured to secure a lid of the shipping container over a base enclosure of the shipping container, the base enclosure housing the payload area.

10. The system of claim 6, wherein the electronic device is a power source for the display.

11. A modular shipping container, comprising:
a lid configured to be opened and closed; and
a base enclosure coupled to the lid and having a payload area that is configured to receive a payload and maintain a temperature of an environment surrounding the payload,
wherein an outer surface of the lid or an exterior wall of the base enclosure defines a cavity configured to house a remote device.

12. The modular shipping container of claim 11, further comprising a tray removably attached to the cavity, the tray configured to receive the remote device.

13. The modular shipping container of claim 12, wherein the tray includes a housing configured to receive the remote device, the housing conforming to a shape of the remote device, the remote device being attachable to the housing via snap-fitment.

14. The modular shipping container of claim 12, wherein the remote device is a display configured to display one or more electronic image files associated with one or more legs of a shipping itinerary or data measured or detected by one or more sensors positioned within the payload area.

15. The modular shipping container of claim 14, wherein the one or more sensors include a thermocouple.

16. The modular shipping container of claim 14, wherein the tray includes wiring configured to electronically couple the display to a data logger configured to receive, store, and transmit the data from the one or more sensors.

17. The modular shipping container of claim 11, wherein a front surface of the remote device is flush with the outer surface of the lid or the exterior wall of the base enclosure when the remote device is housed in the cavity.

18. The modular shipping container of claim 11, wherein the remote device is a data logger configured to receive, store, and transmit data from one or more sensors positioned within the payload area.

19. The modular shipping container of claim 18, wherein one or more channels extend from the cavity, the one or more channels configured to secure wiring to electronically couple the data logger to the one or more sensors.

20. The modular shipping container of claim 11, wherein the cavity is foam.
